(19) United States
(12) Patent Application Publication
(10) Pub. No.: US 2018/0267934 A1
(43) Pub. Date: Sep. 20, 2018

(54) INFORMATION PROCESSING DEVICE, INFORMATION PROCESSING SYSTEM, INFORMATION PROCESSING METHOD, AND RECORDING MEDIUM

(71) Applicant: NEC Corporation, Minato-ku, Tokyo (JP)

(72) Inventors: Ryohei FUJIMAKI, Tokyo (JP); Yusuke MURAOKA, Tokyo (JP)

(73) Assignee: NEC Corporation, Minato-ku, Tokyo (JP)

(21) Appl. No.: 15/755,214

(22) PCT Filed: Sep. 7, 2016
(86) PCT No.: PCT/JP2016/004073

§ 371 Date: Feb. 26, 2018

Related U.S. Application Data
(60) Provisional application No. 62/216,448, filed on Sep. 10, 2015.

(51) Int. Cl. G06F 17/11; G06F 17/16; G06Q 10/04

(52) U.S. Cl. CPC G06F 17/11; G06Q 10/04; G06F 17/16

(57) ABSTRACT

An information processing device according to the present invention includes: a problem generator that, based on a first optimization problem, a lower-dimensional expression that is an expression for approximating uncertain data for the first optimization problem at a lower dimension than a dimension of the uncertain data, and a first data region that is a region of the uncertain data, generates a second optimization problem into that the first optimization problem is transformed in such a way that the second optimization problem relates to the lower-dimensional expression, and a second data region into that the first data region is transformed; and a problem solver that computes an optimum solution to the second optimization problem by using the second data region.

### TECHNICAL FIELD

The present invention relates to information processing, and particularly relates to an information processing device, an information processing system, an information processing method, and a recording medium which compute an optimum solution.

### BACKGROUND ART

In many fields such as production management, inventory management, or asset management, processing for computing an optimum solution based on a given parameter is often carried out. Hereinafter, the above mentioned processing (or, definition of the processing) are referred to as “optimization problem”.

However, the given parameter includes uncertainty due to performance of a detector (sensor), a predictive error, influence of a disturbance, or the like. Therefore, processing for computing optimum solutions based on data including the uncertainty (uncertain data), frequently occurs.

For example, a computation of a weather predictive value with using data of a meteorological observation sensor which includes an error is exemplified.

For a general optimization method for finding out an optimum value, it is difficult to appropriately find out the optimum value when the uncertain data is included in data.

As a method to solve the optimization problem with using the uncertain data, a robust optimization method (hereinafter, referred to as “robust optimization”) is proposed (refers to, for example, a non-patent literature 1 and a non-patent literature 2).

According to the robust optimization, an optimum solution of a control variable is computed based on the following operation. Firstly, according to the robust optimization, an optimization problem which is a target of optimization and defined in advance is acquired. Hereinafter, it is assumed in the following explanation that the optimization problem in the robust optimization is defined by use of the control variable, the uncertain data, an objective function, and a constraint. Then, according to the robust optimization, a region of values that the uncertain data can take (error region) is estimated (determined). Further, according to the robust optimization, worst values of the objective function are computed over a whole of the estimated error region. Then, according to the robust optimization, a control variable which makes the worst value of the objective function the best value (optimum value) is selected out of the control variables which satisfy the constraint over the whole error region as the optimum solution. That is, the robust optimization sets the region of the uncertain data and solves the optimization problem including the uncertain data.

As mentioned above, according to the robust optimization, it is possible to find out the optimum solution of the control variable which satisfies the constraint without severely deteriorating the value of the objective function even when the optimization problem includes the uncertain data having the error.

Note that data which are used in the optimization problem such as the uncertain data and the like are expressed in forms of vectors. Then, “dimension” is used in the following as the number of variables. For example, it is expressed as “high dimension” that the number of variables is large. In contrast, it is expressed as “low dimension” that the number of variables is small.

### CITATION LIST

### Non Patent Literature

[NPL 1] Aharon Ben-Tal, Laurent El Ghaoui, Arkadi Nemirovski, “Robust Optimization”, Princeton University Press, pp 16-23, Aug. 10, 2009

[NPL 2] Giuseppe Calafiore, Marco C. Campi, “Uncertain convex programs: randomized solutions and confidence levels”, Mathematical Programming, Volume 102, Issue, pp 25-46, January 2005

### SUMMARY INVENTION

### Technical Problem

Recently, targets for optimization become expanding. Therefore, a number of the uncertain data which is included in the optimization problem increases (becomes high dimensional). That is, the uncertain data becomes high dimensional. However, when the uncertain data are high dimensional, the methods described in the NPL 1 and the NPL 2 (robust optimization described in the non-patent literature 1 and the non-patent literature 2) become unstable.

The reason is based on the following. That is, according to the robust optimization, it is necessary to estimate the region of the uncertain data. Here, the error region used in the optimization is a combination of the error regions of the uncertain data. In general, a number of combinations increases exponentially as a number of elements to be combined. That is, the number of combinations increases exponentially when a number of dimensions of the uncertain data becomes increasing. When the number of combinations increases, variance in estimating the error region becomes large (unstable) when the number of combinations becomes increasing. As mentioned above, according to the robust optimization described in the NPL 1 and the NPL 2, because an error region which is effective for optimization is not possible to be set when the uncertain data becomes high dimensional, the stable optimum solution cannot be found out.

That is, according to the robust optimization which is described in the NPL 1 and the NPL 2, because it is unstable to estimate the error region as mentioned above when the uncertain data is high dimensional, presenting the following problems.

(1) A result which can be computed is severely deteriorated.

(2) A solution which can be computed does not satisfy the constraint.

As mentioned above, the NPL 1 and the NPL 2 present the problem in which the optimum solution cannot be found out when the optimization problem includes the high-dimensional uncertain data.

An object of the present invention is to solve the above-mentioned problem, and to provide an information processing device, an information processing system, an information processing method, and a recording medium which can find out an optimum solution to the optimization problem including the high-dimensional uncertain data.

### Solution to Problem

An information processing device according to one aspect of the present invention includes: problem generating means for, based on a first optimization problem, a lower-dimensional expression that is an expression for approximating uncertain data for the first optimization problem at a lower dimension than a dimension of the uncertain data, and a first data region that is a region of the uncertain data, generating a second optimization problem into that the first optimization problem is transformed in such a way that the second optimization problem relates to the lower-dimensional expression, and a second data region into that the first data region is transformed; and problem solving means for computing an optimum solution to the second optimization problem by using the second data region.

An information processing system according to one aspect of the present invention includes: a problem generating device that, based on a first optimization problem, a lower-dimensional expression that is an expression for approximating uncertain data for the first optimization problem at a lower dimension than a dimension of the uncertain data, and a first data region that is a region of the uncertain data, generates a second optimization problem into that the first optimization problem is transformed in such a way that the second optimization problem relates to the lower-dimensional expression, and a second data region into that the first data region is transformed; a problem solving device that computes an optimum solution to the second optimization problem by using the second data region; an input device that inputs the first optimization problem, the lower-dimensional expression, and the first data region into each device; and a network that connects the devices each other.

An information processing method according to one aspect of the present invention includes: based on a first optimization problem, a lower-dimensional expression that is an expression for approximating uncertain data for the first optimization problem at a lower dimension than a dimension of the uncertain data, and a first data region that is a region of the uncertain data, generating a second optimization problem into that the first optimization problem is transformed in such a way that the second optimization problem relates to the lower-dimensional expression, and a second data region into that the first data region is transformed; and computing an optimum solution to the second optimization problem by using the second data region.

A non-transitory computer-readable recording medium according to one aspect of the present invention records a program. The program makes a computer execute: a step of, based on a first optimization problem, a lower-dimensional expression that is an expression for approximating uncertain data for the first optimization problem at a lower dimension than a dimension of the uncertain data, and a first data region that is a region of the uncertain data, generating a second optimization problem into that the first optimization problem is transformed in such a way that the second optimization problem relates to the lower-dimensional expression, and a second data region into that the first data region is transformed; and a step of computing an optimum solution to the second optimization problem is computed by using the second data region.

### Advantageous Effects of Invention

Based on the present invention, it is possible to bring about an effect that the optimum solution to the optimization problem which includes the high-dimensional uncertain data can be computed.

### BRIEF DESCRIPTION OF DRAWINGS

FIG. 1 is a block diagram illustrating an example of a configuration of an information processing device according to a first example embodiment of the present invention.

FIG. 2 is a block diagram illustrating an example of a configuration of an information processing system according to the first example embodiment.

FIG. 3 is a block diagram illustrating an example of a configuration of a modification of the information processing device according to the first example embodiment.

FIG. 4 is a block diagram illustrating an example of a configuration of an information processing device according to a second example embodiment.

### DESCRIPTION OF EMBODIMENTS

Next, an example embodiment according to the present invention will be explained with reference to drawings.

Here, each drawing explains the example embodiment of the present invention. However, the present invention is not limited to description of each drawing. The same component in each drawing is assigned the same code, and there is a case that repetitive explanation on the same component is omitted.

Moreover, there is a case that, in the drawings which are used for the following explanation, description on a component which has no relation to explanation of the present invention is omitted and not illustrated.

Moreover, the following explanation uses a robust optimization problem which is defined by using “control variable, uncertain data, objective function, and constraint” as an optimization problem which is used for explanation. However, the above mention does not limit the example embodiment of the present invention to the robust optimization problem. The example embodiment of the present invention is also applicable to another optimization problem including uncertain data.

### First Example Embodiment

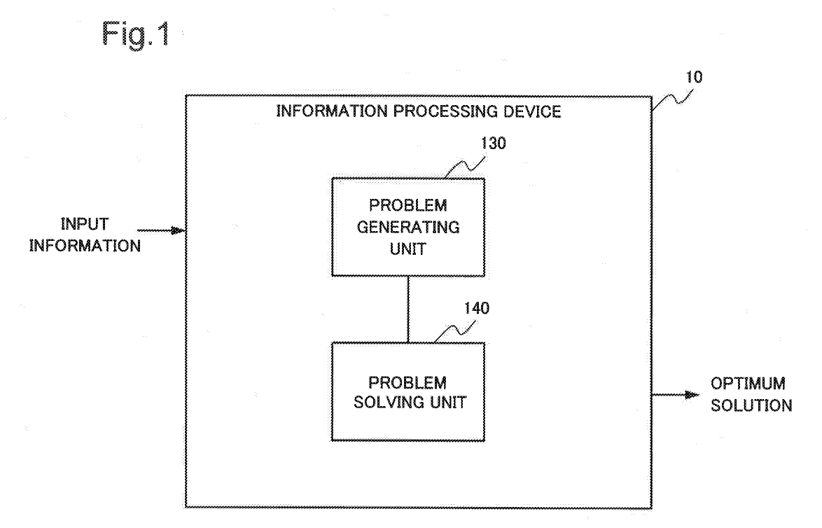

FIG. 1 is a block diagram illustrating an example of a configuration of an information processing device 10 according to a first example embodiment of the present invention.

In order to solve a predetermined optimization problem, the information processing device 10 computes an optimum solution (for example, an optimum solution of a control variable) to the optimization problem based on input information, and outputs the computed optimum solution to a predetermined device. The input information will be explained later in detail. Note that the control variable is a variable which is operable (controllable) in order to optimize an objective function which is an object in the optimization problem. That is, the information processing device 10 outputs the controllable variable as the optimum solution of the optimization problem.

Firstly, the input information which the information processing device 10 according to the first example embodiment receives will be explained.

The information processing device 10 acquires information including three groups of data which will be described in the following as the input information. Note that each group of data includes one piece or a plurality of pieces of data.

[Input Information]

(1) Definition of the optimization problem (hereinafter, denoted as “O”) which includes, at least, uncertain data in a parameter

(2) Lower-dimensional expression of the uncertain data

(3) Region of values that the uncertain data can take

Note that the lower-dimensional expression will be explained later.

The optimization problem (O) is defined based on a control variable, a function, and a constraint which are described in the following in addition to the uncertain data.

Control variable: operable variable

Uncertain data: variable including uncertainty (for example, error)

Objective function: function to be an object of optimization

Constraint: condition which the optimum solution has to satisfy

The information processing device 10 computes (generates) the optimization problem in which the optimum solution can be computed based on the input information. In the following explanation, in order to clarify the explanation, the definition of the optimization problem included in the input information is referred to as “first optimization problem”. Moreover, the optimization problem which is generated by the information processing device 10 is referred to as “second optimization problem”.

### Explanation of Configuration

Next, a configuration of the information processing device 10 will be explained.

Here, it is assumed in the following explanation that the information processing device 10 has received the input information. For example, an operator who wants to find out the optimum solution by use of the information processing device 10 only needs to put the input information into the information processing device 10 in advance. Alternatively, the information processing device 10 may receive information related to a provider of the input information. In this case, the information processing device 10 may acquire the input information from the provider if necessary.

As illustrated in FIG. 1, the information processing device 10 includes a problem generating unit 130 and a problem solving unit 140.

The problem generating unit 130 acquires the input information. Then, based on the input information, the problem generating unit 130 generates the second optimization problem by transforming the first optimization problem into an optimization problem in such a way that the second optimization problem is an optimization problem associated to a lower-dimensional expression of the uncertain data, and thereby.

The problem solving unit 140 computes the optimum solution (for example, optimum control variable) to the second optimization problem. Note that the problem solving unit 140 may compute the optimum solution to the second optimization problem by use of a method (for example, the method described in the NPL 1 and the NPL 2) which is used for the general robust optimization.

In the above-mentioned operation, the information processing device 10 estimates a region of the uncertain data in the lower-dimensional expression. To estimate the region of the uncertain data in the lower-dimensional expression is more stable than to estimate the region of the uncertain data in a higher-dimensional expression. Thus, the information processing device 10 enables to find out the optimum solution by using the second optimization problem into which the first optimization problem is transformed, the lower-dimensional expression of the uncertain data, and the region of values that the uncertain data can take.

That is, the information processing device 10 according to the first example embodiment enables to find out a stable result (optimum solution) even when the dimension of the inputted uncertain data is higher than a dimension which enables the optimum solution to be stably computed.

### Explanation of Operation

Next, operations of the information processing device 10 will be explained in detail by using a specific example of information.

(Explanation on Information)

Firstly, information which is used in the following explanation will be explained.

It is assumed that the first optimization problem (O) is defined as follows.

O: optimization problem (definition of the optimization problem)

Control variable: an amount of purchase from each supplier

Uncertain data: prices, amounts of feasible purchases, and demand (however, the prices and the amounts of feasible purchases are values indicated by each supplier.)

Objective function: minimization of a total purchase cost

Constraint: a total of amounts of purchase ≥ an amount of demand, and an amount of purchase ≤ an amount of feasible purchase (indicated by each supplier)

When determining amounts of future purchases, it is not possible to accurately estimate the prices, the amounts of feasible purchases, and the demand of the future. Therefore, the prices, the amounts of feasible purchase, and the demand of the future are the uncertain data. It is assumed in the following explanation that the uncertain data have n dimensions.

Moreover, it is assumed that variables which are used when explaining the above-mentioned information in further detail are given as follows.

A number of supplier's companies is 10. In this case, the prices and the amounts of feasible purchases are composed of 10 pieces of data, respectively. Thus, the dimensions of the uncertain data is 21 dimensions of data (vector) which includes 10 dimensions of the prices, 10 dimensions of the amounts of feasible purchases, and one dimension of the demand. In this case, the above-mentioned n is “21”.

Furthermore, a variable indicating the supplier is denoted as “i”. The price of each supplier is denoted as “Cᵢ”, and a vector expression of the prices is denoted as “C”. The amount of feasible purchase is denoted as “Sᵢ”, and a vector expression of the amounts of feasible purchases is denoted as “S”. The demand is denoted as “D”. That is, the vector indicating the uncertain data is expressed as [C₁, . . . , C₁₀, S₁, . . . , S₁₀, D].

It is assumed that other information included in the optimization problem (O) is given by an equation 1 which will be indicated in the following. The optimization problem (O) is a problem for finding out a control variable P which minimizes the objective function of the equation 1. Note that similarly to the above, “i” indicates the supplier. Moreover, “Σ” indicating a total is a sum related to a subscript (for example, “i”) of each variable.

$$Control variable \text{:} P \\ Uncertain data \text{:} [ \begin{matrix}C \\ S \\ D\end{matrix} ] \\ Objective function \text{:} {min}_{P} {Σ}_{i} {P}_{i} {C}_{i} \\ Constraint \text{:} {Σ}_{i} {P}_{i} \geq D , {P}_{i} \leq {S}_{i} ( ∀ i ) \qquad [ Equation 1 ]$$

Note that the lower-dimensional expression of the uncertain data is a definition of transformation rule expressing the vector indicating the uncertain data by using a vector having a dimension lower than the dimension of the uncertain data.

For example, when pieces of the uncertain data are predictive values, the information processing device 10 may receive a transformation formula which approximates the uncertain data by use of the dimension lower than the dimension of the uncertain data as the lower-dimensional expression and which is computed based on errors between past predictive values and past actual values of the uncertain data.

In further detail, the information processing device 10 may receive a transformation formula which is related to the uncertain data and which is computed in such a way that a relation shown in the following equation 2 is satisfied as a result of a principal component analysis using the past predictive values and the past actual values of the uncertain data.

Here, the principal component analysis is an analysis according to the following procedure.

(1) Compute a variance-covariance matrix of the uncertain data

(2) Compute eigenvalues and eigenvectors which are corresponding to the computed variance-covariance matrix

(3) Keep a predetermined number of the eigenvectors in an order of largeness of the eigenvalues

Note that when a matrix to be a target, the eigenvalue, and the eigenvector are denoted as A, λ, and x (vector x is not a zero vector) respectively, a combination of the eigenvalue and the eigenvector is a combination of a scalar value and a vector respectively which are defined in the following. Therefore, the combination of the eigenvalue and the eigenvector is called “eigenpair”.

Ax=λx

In this example, the information processing device 10 computes eigenvalue decomposition of an inverse matrix (Σ⁻¹) of the variance-covariance matrix (Σ) of the uncertain data (the past predictive values, the actual values, and the demand (vectors C and S, and a scalar D)). Note that the eigenvalue decomposition is expressed by an equation of “Σ⁻¹=P∧P^{T}”. Here, the matrix ∧ is a diagonal matrix which has as diagonal components, a sequence of the eigenvalues arranged in order of largeness. The matrix P is a matrix formed by arranging the eigenvectors related to the eigenvalues in an order of largeness of the related eigenvalues from a left end as a longitudinal vector. Furthermore, in the matrix ∧, a d×d diagonal matrix generated by keeping d number of the eigenvalues in order of largeness of the values is denoted as ∧_{d}. Moreover, in the matrix P, an n×d matrix generated by keeping the eigenvectors related to the matrix ∧A_{d} is denoted as P_{d}. The information processing device 10 receives, for example, a following equation 2 as a transformation formula between a lowered dimension vector (hereinafter, referred to as “vector a”) and the original vector. Note that the matrix ∧_{d}^{1/2} is a square root of the matrix ∧_{d}.

$$a = {Λ}_{d}^{1 / 2} {P}_{d}^{T} [ \begin{matrix}C \\ S \\ D\end{matrix} ] \qquad [ Equation 2 ]$$

As described above, the equation 2 is an equation showing a relation between the uncertain data [C, S, D], and the lowered dimension vector a (hereinafter, an element of the vector a is referred to as “aⱼ”, where j is an integer larger than 0).

In the equation 2, the matrix described in a left side is the vector of the uncertain data. The vector is a [21×1] matrix (21 is the number of pieces of the uncertain data). C, S, and D are a [10×1] matrix, a [10×1] matrix, and a scalar, respectively.

The equation 2 expresses a relation between the uncertain data and the lowered dimension vector based on the linear transformation (linear combination). However, it is not always necessary that the lower-dimensional expression is limited to the linear transformation in the information processing device 10.

As designation of the region of values that the uncertain data can take in this case, for example, a form of an inequality 3 indicated in the following may be used.

$${( [ \begin{matrix}C \\ S \\ D\end{matrix} ] - [ \begin{matrix}\hat{C} \\ \hat{S} \\ \hat{D}\end{matrix} ] )}^{T} {Φ}^{- 1} ( [ \begin{matrix}C \\ S \\ D\end{matrix} ] - [ \begin{matrix}\hat{C} \\ \hat{S} \\ \hat{D}\end{matrix} ] ) \leq ɛ \qquad [ Inequality 3 ]$$

In the inequality 3, “Φ” is a matrix which expresses a variance-covariance matrix of the errors of the predictive values, and “−1” which is a superscript of “Φ” indicates an inverse matrix. A variable with a hat (̂) indicates the predictive value. Therefore, subtraction between the matrices indicated in each parenthesis indicates differences (error) between the actual values and the predictive values of the uncertain data.

Moreover, ϵ is a designated error probability which is related to an ellipse defined by the inequality 3, or a value (however, a positive value) which is acquired by carrying out a predetermined processing to the error probability.

Note that as the error region of the uncertain data, the ellipse is used in the above-mentioned explanation, but the region is not limited to the ellipse.

(Explanation on Operation)

Firstly, the problem generating unit 130 generates the second optimization problem based on the lower-dimensional expression, and the first optimization problem (O). The problem generating unit 130 transforms the first optimization problem into the second optimization problem (The problem generating unit 130 generates the second optimization problem) by transforming the uncertain data included in the first optimization problem (O) in such a way that the uncertain data may be expressed using the formula on the lower-dimensional vector which is based on the lower-dimensional expression. Moreover, the problem generating unit 130 transforms the region (first data region) of values that the uncertain data can take into the region (second data region) (the problem generating unit 130 generates the region (second data region)) on the lower-dimensional vector which is based on the lower-dimensional expression.

For example, the uncertain data in the first optimization problem are [C, S, D]. Therefore, some equations (for example, the objective function) which are included in the first optimization problem are expressed using [C, S, D]. Meanwhile, the lower-dimensional vector based on the lower-dimensional expression is [aⱼ]. The problem generating unit 130 transforms the objective function and all constraints into equations using “aⱼ”. Furthermore, the problem generating unit 130 transforms the region of values that the uncertain data can take into an equation (for example, equation which satisfies the above-mentioned ellipse) related to “aⱼ”. A problem including each of parameters which are acquired by the above-mentioned transformation is the second optimization problem.

Then, the problem solving unit 140 solves the second optimization problem generated by the problem generating unit 130. That is, the problem solving unit 140 finds out the optimum solution (the optimum value of the control variable) to the second optimization problem generated by the problem generating unit 130 generates by using the second data region.

Note that a method which is used for computing the optimum solution to the second optimization problem by the problem solving unit 140 is not limited particularly. The problem solving unit 140 may use a well-known method.

For example, when the generated second optimization problem is a linear programming problem, the problem solving unit 140 may use the method which is described in the NPL 1. Alternatively, when the generated second optimization problem is not the linear programming problem, the problem solving unit 140 may use the method which is described in the NPL 2. According to the methods which are described in the NPL 1 and the NPL 2, it is possible to compute the optimum solution at the low dimension. That is, the information processing device 10 can find out the optimum solution even when the uncertain data are high dimensional.

### Explanation on Effect

Next, an effect of the present example embodiment will be explained.

The information processing device 10 according to the first example embodiment brings about an effect that it is possible to compute the optimum solution to the optimization problem which includes the high-dimensional uncertain data.

The reason is as follows.

The problem generating unit 130 generates the second optimization problem based on the lower-dimensional expression of the uncertain data and the first optimization problem. Then, the problem solving unit 140 solves the second optimization problem by using the region of values that the uncertain data can take. The above is the reason.

The second optimization problem is the problem from which the optimum solution can be computed. That is, the information processing device 10 can compute the optimum solution based on an approximate expression of first uncertain data even when the first uncertain data are high dimensional.

### Modification 1

The information processing device 10 mentioned above is configured as follows.

For example, each of component units of the information processing device 10 may be composed of a hardware circuit.

Alternatively, each of the component units of the information processing device 10 may be configured with using an information processing system which includes a plurality of devices connected each other through a wireless network or a wired network.

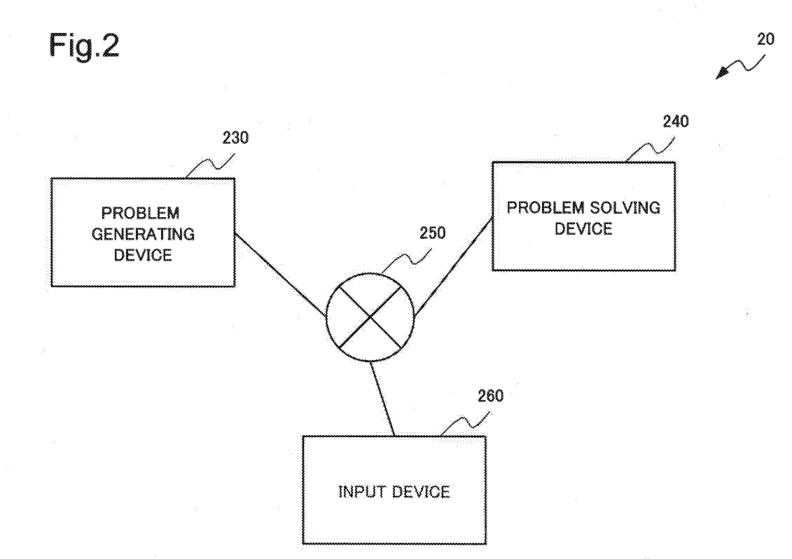

FIG. 2 is a block diagram illustrating an example of a configuration of an information processing system 20 according to the first example embodiment. The information processing system 20 includes a problem generating device 230, a problem solving device 240, a network 250, and an input device 260.

The network 250 connects the devices illustrated in FIG. 2. The input device 260 inputs the input information which has been explained already into a predetermined device. Note that the input device 260 may be a storage device which stores information. In this case, each device which will be explained hereinafter may extract necessary information from the input device 260.

The problem generating device 230 realizes similar functions of the problem generating unit 130 illustrated in FIG. 1. The problem solving device 240 realizes similar functions of the problem solving unit 140 illustrated in FIG. 1.

The information processing system 20, which has the above-mentioned configuration, brings about an effect which is the similar effect of the information processing device 10. The reason is because the information processing system 20 can realize similar functions of the information processing device 10 by using each of the devices mentioned above.

Alternatively, each device of the information processing system 20 may include the functions of the plural devices.

### Modification 2

Alternatively, a plurality of the component units of the information processing device 10 may be composed of one hardware block.

Alternatively, the information processing device 10 may be realized as a computer device which includes a CPU (Central Processing Unit), a ROM (Read Only Memory), and a RAM (Random Access Memory). The information processing device 10 may be realized as a computer device which includes an input and output connection circuit (IOC: Input and Output Circuit) and a network interface circuit (NIC: Network Interface Circuit) in addition to the above-mentioned component units.

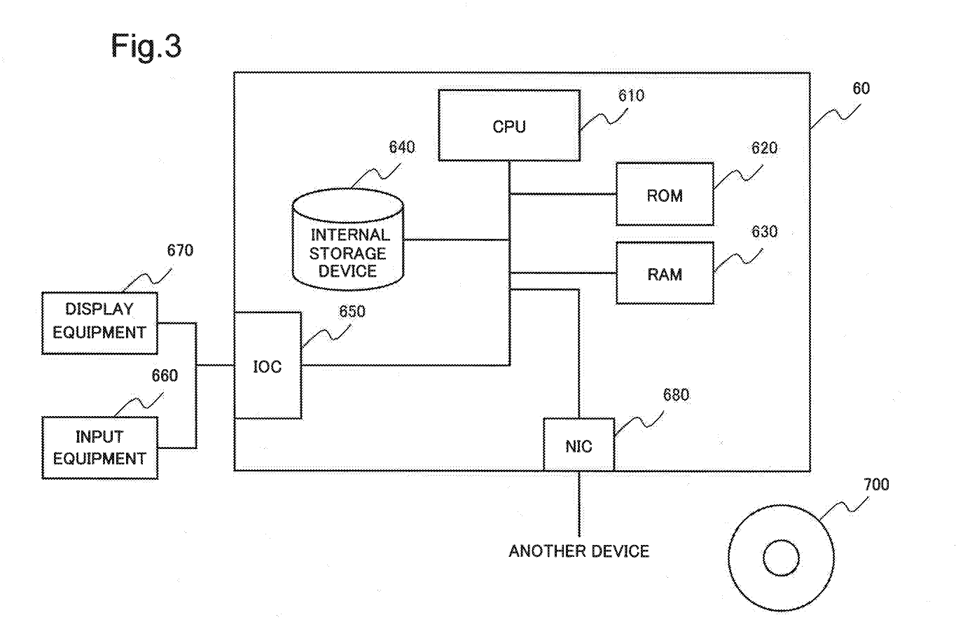

FIG. 3 is a block diagram illustrating an example of a configuration of an information processing device 60 according to a present modification.

The information processing device 60 includes a CPU 610, a ROM 620, and a RAM 630, an internal storage device 640, an IOC 650, and a NIC 680, and composes a computer device.

The CPU 610 reads a program from the ROM 620. Then, the CPU 610 controls the RAM 630, the internal storage device 640, the IOC 650, and the NIC 680 based on the read program. The computer including the CPU 610 controls the above-mentioned components, and realizes the functions of the problem generating unit 130 and the problem solving unit 140 which are illustrated in FIG. 1.

When realizing each of the functions, the CPU 610 may use the RAM 630 or the internal storage device 640 as a temporary storage device for the program.

Moreover, the CPU 610 may read the program stored in a storage medium 700 which computer-readably stores a program by using a storage medium reading device not illustrated in the drawing. Alternatively, the CPU 610 may receive a program from an external device which is not illustrated in the drawing through the NIC 680, and stores the program in the ROM 620, the RAM 630, or the internal storage device 640, and may operate based on the stored program.

The ROM 620 stores a program and fixed data which the CPU 610 executes. The ROM 620 is, for example, a P-ROM (Programmable-ROM) or a Flash ROM.

The RAM 630 temporarily stores a program and data which the CPU 610 executes. The RAM 630 is, for example, a D-RAM (Dynamic-RAM).

The internal storage device 640 stores data and a program which the information processing device 60 saves for a long time. Moreover, the internal storage device 640 may operate as a temporary storage device of the CPU 610. The internal storage device 640 is, for example, a hard disk device, a magneto-optical disk device, a SSD (Solid State Drive), or a disk array device.

Here, the ROM 620 and the internal storage device 640 are non-volatile (non-transitory) storage media. In contrast, the RAM 630 is a volatile (transitory) storage media. Then, the CPU 610 can operate based on the program stored in the ROM 620, the internal storage device 640, or the RAM 630. That is, the CPU 610 can operate by use of the non-volatile storage medium or the volatile memory medium.

The IOC 650 mediates data exchange between the CPU 610 and input equipment 660 and between the CPU 610 and display equipment 670. The IOC 650 is, for example, an IO interface card or a USB (Universal Serial Bus) card.

The input equipment 660 is equipment which receives an input instruction from an operator of the information processing device 60. The input equipment 660 is, for example, a keyboard, a mouse, or a touch panel. Note that the input equipment 660 may be used for inputting the input information.

The display equipment 670 is equipment which displays information to the operator of the information processing device 60.

The display equipment 670 is, for example, a liquid crystal display. Note that the display equipment 670 may display the optimum solution which the problem solving unit 140 outputs.

The NIC 680 relays data exchange with an external device which is not illustrated in the drawing through the network. The NIC 680 is, for example, a LAN (Local Area Network) card. Note that the NIC 680 may be used for inputting the input information or outputting the optimum solution.

The information processing device 60 configured in this manner brings about a similar effect of the information processing device 10.

The reason is because the CPU 610 of the information processing device 60 can realize similar functions of the information processing device 10 based on the program.

Note that the problem generating device 230, the problem solving device 240, and the input device 260 which are illustrated in FIG. 2 may be configured with use of the computer device illustrated in FIG. 3.

### Second Example Embodiment

The information processing device 10 may include an element that generates the lower-dimensional expression of the uncertain data and/or an element that computes the region in which the uncertain data enables to acquire a value.

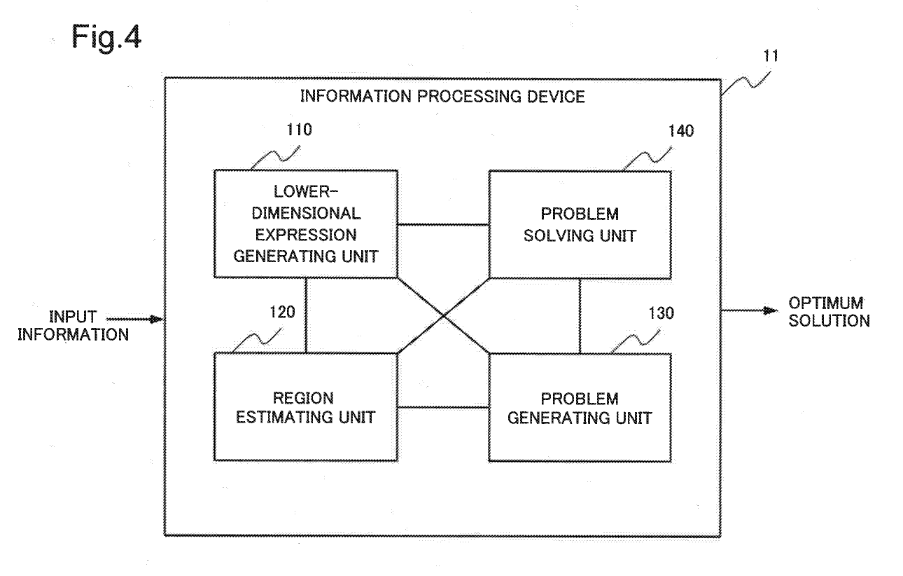

FIG. 4 is a block diagram illustrating an example of a configuration of an information processing device 11 according to a second example embodiment.

As illustrated in FIG. 4, the information processing device 11 includes a lower-dimensional expression generating unit 110 and a region estimating unit 120 in addition to the configuration of the information processing device 10. Since other configuration is the similar configuration of the first example embodiment, detailed explanation on the other configuration is omitted.

Note that the information processing device 11 may be configured with use of the computer device illustrated in FIG. 3. Alternatively, the information processing device 11 may be configured with use of a system which includes a device realizing a function of the lower-dimensional expression generating unit 110, and a device realizing a function of the region estimating unit 120 in addition to the information processing system 20 shown in FIG. 2.

The lower-dimensional expression generating unit 110 generates the lower-dimensional expression of the uncertain data included in the input information. The lower-dimensional expression generating unit 110 generates the lower-dimensional expression based on the operation which corresponds to the equation 2 or the inequality 3. For example, the lower-dimensional expression generating unit 110 may generate the lower-dimensional expression based on a sequence of observed values and/or true values of the uncertain data. Note that the true value is a value (for example, a past actual value) of the uncertain data which does not include a past error. However, the lower-dimensional expression generating unit 110 may use a lower-dimensional expression other than the above-mentioned lower-dimensional expression.

Then, the lower-dimensional expression generating unit 110 transmits the generated lower-dimensional expression to the problem generating unit 130 and the problem solving unit 140. The lower-dimensional expression generating unit 110 may alternatively transmit the lower-dimensional expression to the region estimating unit 120 which will be explained in the following.

The region estimating unit 120 estimates the region of values that the uncertain data can take included in the input information. A method which the region estimating unit 120 uses for estimating the region is not limited in particular. For example, the region estimating unit 120 may use the method which is described in the NPL 1. Alternatively, the region estimating unit 120 may estimate the first data region based on the sequence of the observed values and/or the true values of the uncertain data.

The information processing device 11 according to the second example embodiment can bring about an effect of reducing works of a provider of the input information in addition to the effect of the information processing device 10 according to the first example embodiment.

The reason is because, since the lower-dimensional expression generating unit 110 computes the lower-dimensional expression of the uncertain data included in the input information and the region estimating unit 120 computes the region of values that the uncertain data can take respectively, a provider of the input information has no necessity to generate the above-mentioned information when computing the optimization.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from U.S.-provisional application No. 62/216,448, filed on Sep. 10, 2015, the disclosure of which is incorporated herein in its entirety by reference.

### INDUSTRIAL APPLICABILITY

The present invention is applicable to solving the optimization problem which includes the uncertain data. Moreover, the present invention is applicable to SaaS (Software as a Service). That is, it is possible to provide a user of the present invention with the present invention using a form of SaaS.

### REFERENCE SIGNS LIST

10 Information processing device

11 Information processing device

20 Information processing system

60 Information processing device

110 Lower-dimensional expression generating unit

120 Region estimating unit

130 Problem generating unit

140 Problem solving unit

230 Problem generating device

240 Problem solving device

250 Network

260 Input device

610 CPU

620 ROM

630 RAM

640 Internal storage device

650 IOC

660 Input equipment

670 Display equipment

680 NIC

700 Storage medium

What is claimed is:

1. An information processing device comprising:
a problem generator that, based on a first optimization problem, a lower-dimensional expression that is an expression for approximating uncertain data for the first optimization problem at a lower dimension than a dimension of the uncertain data, and a first data region that is a region of the uncertain data, generates a second optimization problem into that the first optimization problem is transformed in such a way that the second optimization problem relates to the lower-dimensional expression, and a second data region into that the first data region is transformed; and
a problem solver that computes an optimum solution to the second optimization problem by using the second data region.

2. The information processing device according to claim 1, further comprising:
a lower-dimensional expression generator that generates the lower-dimensional expression based on a sequence of observed values and/or true values of the uncertain data; and
a region estimator that estimates the first data region based on the sequence of the observed values and/or the true values of the uncertain data.

3. The information processing device according to claim 2, wherein
the lower-dimensional expression generator, as the lower-dimensional expression, uses a linear combination of a predetermined number of eigenvalues, eigenvalue vectors that are corresponding to the predetermined number of the eigenvalues, the predetermined number of eigenvalues being obtained by applying a principal component analysis to a variance-covariance matrix of the uncertain data and, of obtained eigenvalues, selecting the predetermined number of eigenvalues in order of largeness.

4. (canceled)

5. An information processing method comprising:
based on a first optimization problem, a lower-dimensional expression that is an expression for approximating uncertain data for the first optimization problem at a lower dimension than a dimension of the uncertain data, and a first data region that is a region of the uncertain data, generating a second optimization problem into that the first optimization problem is transformed in such a way that the second optimization problem relates to the lower-dimensional expression, and a second data region into that the first data region is transformed; and
computing an optimum solution to the second optimization problem by using the second data region.

6. A non-transitory computer-readable recording medium embodying a program, the program causing a computer to perform a method, the method comprising:
based on a first optimization problem, a lower-dimensional expression that is an expression for approximating uncertain data for the first optimization problem at a lower dimension than a dimension of the uncertain data, and a first data region that is a region of the uncertain data, generating a second optimization problem into that the first optimization problem is transformed in such a way that the second optimization problem relates to the lower-dimensional expression, and a second data region into that the first data region is transformed; and
computing an optimum solution to the second optimization problem is computed by using the second data region.
